(19) United States
(12) Patent Application Publication
(10) Pub. No.: US 2007/0120279 A1
(43) Pub. Date: May 31, 2007

(54) Method for coating lens material

(75) Inventors: Jeffrey Linhardt, Fairport, NY (US); Joseph C. Salamone, Boca Raton, FL (US); Daniel M. Ammon JR., Penfield, NY (US); Daniel J. Hook, Fairport, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/604,551

(22) Filed: Nov. 27, 2006

Related U.S. Application Data
(60) Provisional application No. 60/740,535, filed on Nov. 29, 2005.

(51) Int. Cl. B29D 11/00

(52) U.S. Cl. 264/1.7; 427/163.1

(57) ABSTRACT

This invention relates generally to a method for treatment of lens surfaces by first coating the mold material with a reactive macromonomer and subsequently casting and curing the lens forming material along with the coating material present on the surface of the mold. The macromonomer reacts with the lens monomer mix and is covalently bound to the lens matrix. The modified lenses may ultimately show enhanced wettability, inhibition of bacterial adhesion and lower levels of protein and lipid deposition leading to increased comfort and longer wearing times.

### CROSS REFERENCE

This application claims the benefit of Provisional Patent Application No. 60/740,535 filed Nov. 29, 2005 and is incorporated herein by reference.

### FIELD

This invention relates generally to a method for treatment of lens surfaces by first coating the mold material with a reactive macromonomer and subsequently casting and curing the lens forming material along with the reactive macromonomer coating material present on the surface of the mold. The macromonomer reacts with the lens monomer mix and is covalently bound to the lens matrix. The modified lenses may ultimately show enhanced wettability, inhibition of bacterial adhesion and lower levels of protein and lipid deposition leading to increased comfort and longer wearing times.

### BACKGROUND AND BRIEF DESCRIPTION OF THE INVENTION

Poloxamer block copolymers are known compounds and are generally available under the trademark PLURONIC. Poloxamers generally have the following structure:
HO(C₂H₄O)ₐ(C₃H₆O)_{b}(C₂H₄O)ₐH
Reverse poloxamers are also known block copolymers and generally have the following structure:
HO(C₃H₆O)_{b}(C₂H₄O)ₐ(C₃H₆O)_{b}H

Poloxamers and reverse poloxamers have end-terminal hydroxyl groups that can be functionalized. An example of an end-terminal functionalized poloxamer is poloxamer dimethacrylate (Pluronic F-127 dimethacrylate) as disclosed in U.S. Patent Publication No. 2003/0044468 to Cellesi et al. U.S. Pat. No. 6,517,933 discloses glycidyl-terminated copolymers of poly(ethylene glycol) and poly(propylene glycol).

Poloxamers and reverse poloxamers are surfactants with varying HLB values based upon the varying values of a and b, a representing the number of hydrophilic [poly(ethylene oxide)] units (PEO) being present in the molecule and b representing the number of hydrophobic [poly(propylene oxide)] units (PPO) being present in the molecule. While poloxamers and reverse poloxamers are considered to be difunctional molecules (based on the terminal hydroxyl groups) they are also available in a tetrafunctional form known as poloxamines, trade name TETRONIC. For poloxamines, the molecules are tetrafunctional block copolymers terminating in primary hydroxyl groups and linked by a central diamine. Poloxamines have the following general structure: 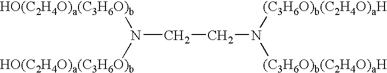
Reverse poloxamines are also known and have varying HLB values based upon the relative ratios of a to b.

Polyethers that are present at the surface of substrates have long been known to create non-fouling surfaces by inhibiting adsorption. In the present invention, we chemically modify poloxamer and poloxamine block copolymers (BASF Corp.) and use them to coat medical devices by copolymerizing in the lens matrix from the surface of the molding material.

Medical devices such as ophthalmic lenses made from silicon-containing materials have been investigated for a number of years. Such materials can generally be subdivided into two major classes, namely hydrogels and non-hydrogels. Non-hydrogels do not absorb appreciable amounts of water, whereas hydrogels can absorb and retain water in an equilibrium state. Regardless of their water content, both non-hydrogel and hydrogel silicon containing medical devices tend to have relatively hydrophobic, non-wettable surfaces that have a high affinity for lipids. This problem is of particular concern with contact lenses.

Those skilled in the art have long recognized the need for modifying the surface of such silicon containing contact lenses so that they are compatible with the eye. It is known that increased hydrophilicity of the contact lens surface improves the wettability of the contact lenses. This in turn is associated with improved wear comfort of contact lenses. Additionally, the surface of the lens can affect the lens's susceptibility to deposition, particularly the deposition of proteins and lipids from the tear fluid during lens wear. Accumulated deposition can cause eye discomfort or even inflammation. In the case of extended wear lenses (i.e. lenses used without daily removal of the lens before sleep), the surface is especially important, since extended wear lens must be designed for high standards of comfort and biocompatibility over an extended period of time.

Silicon containing lenses have been subjected to plasma surface treatment to improve their surface properties, e.g., surfaces have been rendered more hydrophilic, deposit resistant, scratch-resistant, or otherwise modified. Examples of previously disclosed plasma surface treatments include subjecting contact lens surfaces to a plasma comprising an inert gas or oxygen (see, for example, U.S. Pat. Nos. 4,055,378; 4,122,942; and 4,214,014); various hydrocarbon monomers (see, for example, U.S. Pat. No. 4,143,949); and combinations of oxidizing agents and hydrocarbons such as water and ethanol (see, for example, WO 95/04609 and U.S. Pat. No. 4,632,844). U.S. Pat. No. 4,312,575 to Peyman et al. discloses a process for providing a barrier coating on a silicon containing or polyurethane lens by subjecting the lens to an electrical glow discharge (plasma) process conducted by first subjecting the lens to a hydrocarbon atmosphere followed by subjecting the lens to oxygen during flow discharge, thereby increasing the hydrophilicity of the lens surface.

U.S. Pat. Nos. 4,168,112, 4,321,261 and 4,436,730, all issued to Ellis et al., disclose methods for treating a charged contact lens surface with an oppositely charged ionic polymer to form a polyelectrolyte complex on the lens surface that improves wettability.

U.S. Pat. No.4,287,175 to Katz discloses a method of wetting a contact lens that comprises inserting a water-soluble solid polymer into the cul-de-sac of the eye. The disclosed polymers include cellulose derivatives, acrylates and natural products such as gelatin, pectins and starch derivatives.

U.S. Pat. No. 5,397,848 to Yang et al. discloses a method of incorporating hydrophilic constituents into silicon containing polymer materials for use in contact and intra-ocular lenses.

U.S. Pat. Nos. 5,700,559 and 5,807,636, both to Sheu et al., discloses hydrophilic articles (for example, contact lenses) comprising a substrate, an ionic polymeric layer on the substrate and a disordered polyelectrolyte coating ionically bonded to the polymeric layer.

U.S. Pat. No. 5,705,583 to Bowers et al. discloses biocompatible polymeric surface coatings. The polymeric surface coatings disclosed include coatings synthesized from monomers bearing a center of positive charge, including cationic and zwitterionic monomers.

European Patent Application EP 0 963 761 A1 discloses biomedical devices with coatings that are said to be stable, hydrophilic and antimicrobial, and which are formed using a coupling agent to bond a carboxyl-containing hydrophilic coating to the surface by ester or amide linkages.

U.S. Pat. No. 6,428,839 to Kunzler et al. teaches contacting a medical device that has not been subjected to surface oxidation with a solution comprising a proton-donating wetting agent to form a complex between the wetting agent and the hydrophilic monomer on the medical device.

Polymerizable poloxamers and poloxamines as comonomers in forming polymeric devices have been developed and are disclosed in U.S. patent application Ser. No. 11/020,541, the content of which is incorporated by reference herein.

Because of the hydrophobic lipophilic balance (HLB) of these surfactants, the use of these materials as surface coatings for biomedical devices provides desirable results with regard to bacterial attachment and lipid deposition.

Surface structure and composition determine many of the physical properties and ultimate uses of solid materials. Characteristics such as wetting, friction, and adhesion or lubricity are largely influenced by surface characteristics. The alteration of surface characteristics is of special significance in biotechnical applications where biocompatibility is of particular concern. Thus, it is desired to provide a silicon containing hydrogel contact lens with an optically clear, hydrophilic surface film that will not only exhibit improved wettability, but which will generally allow the use of a silicon containing hydrogel contact lens in the human eye for extended period of time. In the case of a silicon containing hydrogel lens for extended wear, it would be further desirable to provide an improved silicon-containing hydrogel contact lens with an optically clear surface film that will not only exhibit improved lipid and microbial behavior, but which will generally allow the use of a silicon-containing hydrogel contact lens in the human eye for an extended period of time. Such a surface treated lens would be comfortable to wear in actual use and would allow for the extended wear of the lens without irritation or other adverse effects to the cornea.

It would also be desirable to apply these surface enhancing coatings to implantable medical devices such as intraocular lens materials to reduce the attachment of lens epithelial cells to the implanted device and to reduce friction as the intraocular lens passes through an inserter into the eye.

For this particular application a reactive monomer is dissolved in a solvent (e.g., an organic solvent) and this mixture is used to coat the surface of a lens mold by one of the known methods to those skilled in the art (i.e. spin coating or spray coating). When the lens monomer mixture is placed in the mold and polymerized, the coating material is copolymerized into the lens matrix and is present at the surface of the lens. The solubility of the coating material in the lens formulation can be modulated to allow from partial to complete dissolution of the reactive monomer into the formulation. The reason that at least partial dissolution of the surface coating material is required is to facilitate copolymerization with the lens matrix monomers. Coating of the molds can be optimized by coating solvent, concentration of reactive monomer in the solvent, spin speed (in the case of spin coating), and spraying conditions.

### BRIEF DESCRIPTION OF THE DRAWINGS

FIG. 1 is an XPS Spectrum of Contact Lens Surfaces made according to the invention.

### DETAILED DESCRIPTION

As utilized herein the term “monomer” refers to any molecule capable of participating in a polymerization reaction. Therefore the term monomer is inclusive of similar terms such as “macromonomer”.

The method of the present invention is useful with biocompatible materials including both soft and rigid materials commonly used for ophthalmic lenses, including contact lenses. The preferred substrates are hydrogel materials, including silicon containing hydrogel materials. Particularly preferred materials include vinyl functionalized polydimethylsiloxanes copolymerized with hydrophilic monomers as well as fluorinated methacrylates and methacrylate functionalized fluorinated poly(ethylene oxide)s copolymerized with hydrophilic monomers. The present invention relates generally to reactive surfactants and compositions comprising the surfactants as covalently bound coatings used in the manufacture of medical devices. More specifically, the present invention relates to surface coated ophthalmic lenses formed from one or more functionalized poloxamers or poloxamines that are copolymerizable with the ophthalmic lens monomer mixture.

As used herein, the expression “lens monomer mix” and word of similar import refers to monomers, comonomers, initiators, crosslinkers, tints and other materials as are typically used to make medical devices such as contact lenses.

Examples of substrate materials useful in the present invention are taught in U.S. Pat. No. 5,908,906 to Künzler et al.; U.S. Pat. No. 5,714,557 to Künzler et al.; U.S. Pat. No. 5,710,302 to Künzler et al.; U.S. Pat. No. 5,708,094 to Lai et al.; U.S. Pat. No. 5,616,757 to Bambury et al.; U.S. Pat. No. 5,610,252 to Bambury et al.; U.S. Pat. No. 5,512,205 to Lai; U.S. Pat. No. 5,449,729 to Lai; U.S. Pat. No. 5,387,662 to Künzler et al.; U.S. Pat. No. 5,310,779 to Lai and U.S. Pat. No. 6,891,010 to Künzler et al.; which patents are incorporated by reference as if set forth at length herein.

While the present invention contemplates the use of end terminal functionalized copolymers for medical devices including all types of contact or intraocular lenses, the devices comprising the end-terminal functionalized copolymer coatings of the present invention are thought to be especially useful as soft hydrogel contact lenses. As is understood in the field, a lens is considered to be “soft” if it can be folded back upon itself without breaking.

The invention is applicable to a wide variety of materials, and silicon containing hydrogel contact lens materials are particularly preferred. Hydrogels in general are a well-known class of materials that comprise hydrated, crosslinked polymeric systems containing water in an equilibrium state. Silicon containing hydrogels generally have a water content greater than about 5 weight percent and more commonly between about 10 to about 80 weight percent. Such materials are usually prepared by polymerizing a mixture containing at least one siloxy-containing monomer and at least one hydrophilic monomer. Typically, either the silicon-containing monomer or the hydrophilic monomer functions as a crosslinking agent (a crosslinker being defined as a monomer having multiple polymerizable functionalities) or a separate crosslinker may be employed. Applicable silicon-containing monomeric units for use in the formation of silicon containing hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Examples of applicable silicon-containing monomeric units include bulky polysiloxanylalkyl (meth)acrylic monomers. An example of bulky polysiloxanylalkyl (meth)acrylic monomers are represented by the following Formula I:

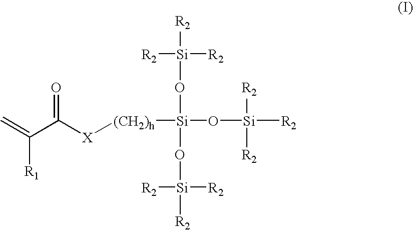

wherein:

X denotes —O— or —NR—;

each R₁ independently denotes hydrogen or methyl;

each R₂ independently denotes a lower alkyl radical, phenyl radical or a group represented by

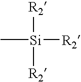

wherein each R′_{2′}independently denotes a lower alkyl or phenyl radical; and h is 1 to 10.

Some preferred bulky monomers are methacryloxypropyltris(trimethyl-siloxy)silane or tris(trimethylsiloxy)silylpropyl methacrylate, sometimes referred to as TRIS.

Another class of representative silicon-containing monomers includes silicon containing-containing vinyl carbonate or vinyl carbamate monomers such as: 1,3-bis[4-vinyloxycarbonyloxy)but-1-yl]tetramethyldisiloxane; 3-(trimethylsilyl)propyl vinyl carbonate; 3-(vinyloxycarbonylthio)propyl[tris(trimethylsiloxy)silane]; 3-[tris(tri-methylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; and trimethylsilylmethyl vinyl carbonate.

An example of silicon-containing vinyl carbonate or vinyl carbamate monomers are represented by Formula II: 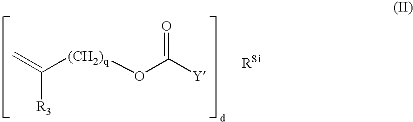
wherein:

Y′ denotes —O—, —S— or —NH—;

R^{Si} denotes a silicone containing organic radical;

R₃ denotes hydrogen or methyl;

d is 1,2,3or 4;and q is 0 or1.

Suitable silicon containing organic radicals R^{Si} include the following: 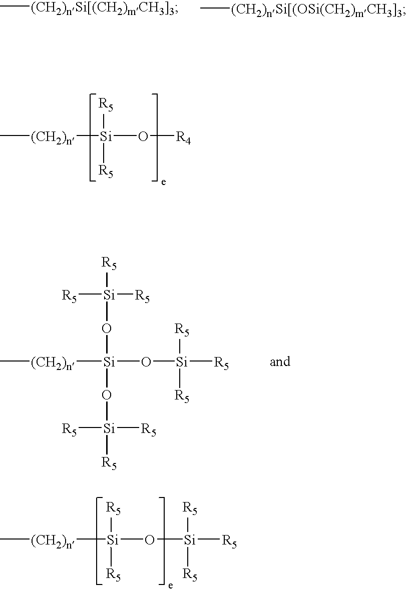
wherein:

R₄ denotes 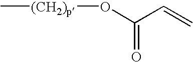
wherein p′ is 1 to 6;

R₅ denotes an alkyl radical or a fluoroalkyl radical having 1 to 6 carbon atoms;

e is 1 to 200; n′ is 1, 2, 3 or 4; and m′ is 0, 1, 2, 3, 4 or 5.

An example of a particular species within Formula II is represented by Formula III.

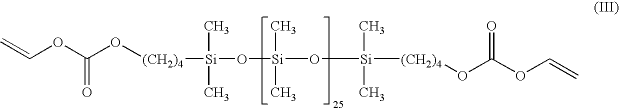

Another class of silicon-containing monomers includes polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacryates in Polyurethane-Polysiloxane Hydrogels,” Journal of Applied Polymer Science, Vol.60, 1193-1199 (1996). PCT Published Application No. WO 96/31792 discloses examples of such monomers, which disclosure is hereby incorporated by reference in its entirety. Further examples of silicone urethane monomers are represented by Formulae IV and V:
E(*D*A*D*G)ₐ*D*A*D*E′; or (IV)
E(*D*G*D*A)ₐ*D*G*D*E′; (V)
wherein:

D denotes an alkyl diradical, an alkyl cycloalkyl diradical, a cycloalkyl diradical, an aryl diradical or an alkylaryl diradical having 6 to 30 carbon atoms;

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

* denotes a urethane or ureido linkage;

a is at least 1;

A denotes a divalent polymeric radical of Formula VI: 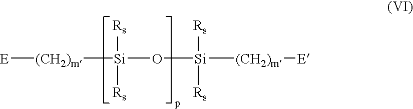
wherein:

each R_{S} independently denotes an alkyl or fluoro-substituted alkyl group having 1 to 10 carbon atoms which may contain ether linkages between carbon atoms;

m′ is at least 1; and

p is a number which provides a moiety weight of 400 to 10,000;

each of E and E′ independently denotes a polymerizable unsaturated organic radical represented by Formula VII: 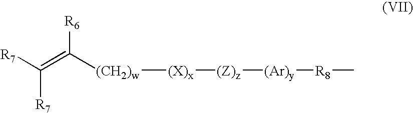
wherein:

R₆ is hydrogen or methyl;

R₇ is hydrogen, an alkyl radical having 1 to 6 carbon atoms, or a —CO—Y—R₉ radical wherein Y is —O—, —S— or —NH—;

R₈ is a divalent alkylene radical having 1 to 10 carbon atoms;

R₉ is a alkyl radical having 1 to 12 carbon atoms;

X denotes —CO— or —OCO—;

Z denotes —O— or —NH—;

Ar denotes an aromatic radical having 6 to 30 carbon atoms;

w is 0 to 6; x is 0 or 1; y is 0 or 1; and z is 0 or 1.

A more specific example of a silicon containing urethane monomer is represented by Formula (VIII): 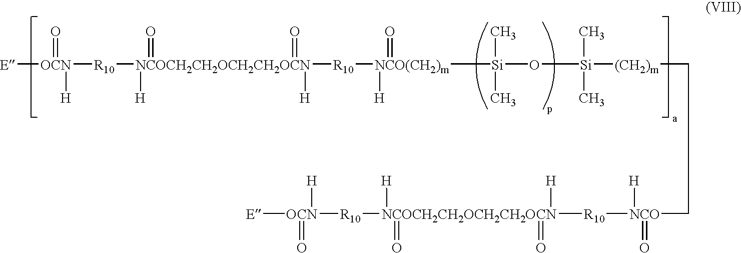
wherein m is at least 1 and is preferably 3 or 4, a is at least 1 and preferably is 1, p is a number which provides a moiety weight of 400 to 10,000 and is preferably at least 30, R₁₀ is a diradical of a diisocyanate after removal of the isocyanate group, such as the diradical of isophorone diisocyanate, and each E″ is a group represented by:

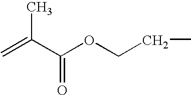

A preferred silicon containing hydrogel material comprises (in the bulk monomer mixture that is copolymerized) 5 to 50 percent, preferably 10 to 25, by weight of one or more silicon containing macromonomers, 5 to 75 percent, preferably 30 to 60 percent, by weight of one or more polysiloxanylalkyl (meth)acrylic monomers, and 10 to 50 percent, preferably 20 to 40 percent, by weight of a hydrophilic monomer. In general, the silicon containing macromonomer is a poly(organosiloxane) capped with an unsaturated group at two or more ends of the molecule. In addition to the end groups in the above structural formulas, U.S. Pat. No. 4,153,641 to Deichert et al. discloses additional unsaturated groups, including acryloxy or methacryloxy. Fumarate-containing materials such as those taught in U.S. Pat. Nos. 5,512,205; 5,449,729; and 5,310,779 to Lai are also useful substrates in accordance with the invention. Preferably, the silane macromonomer is a silicon-containing vinyl carbonate or vinyl carbamate or a polyurethane-polysiloxane having one or more hard-soft-hard blocks and end-capped with a hydrophilic monomer.

Suitable hydrophilic monomers include those monomers that, once polymerized, can form a complex with poly(acrylic acid). The suitable monomers form hydrogels, such as silicon-containing hydrogel materials useful in the present invention and include, for example, monomers that form complexes with poly(acrylic acid) and its derivatives. Examples of useful monomers include amides such as N,N-dimethylacrylamide, N,N-dimethylmethacrylamide, cyclic lactams such as N-vinyl-2-pyrrolidone and poly(alkene glycol)s functionalized with polymerizable groups. Examples of useful functionalized poly(alkene glycol)s include poly(diethylene glycol)s of varying chain length containing monomethacrylate or dimethacrylate end caps. In a preferred embodiment, the poly(alkene glycol) polymer contains at least two alkene glycol monomeric units. Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art.

In particular regard to contact lenses, the fluorination of certain monomers used in the formation of silicon containing hydrogels has been indicated to reduce the accumulation of deposits on contact lenses made therefrom, as described in U.S. Pat. Nos. 4,954,587, 5,079,319, 5,010,141 and 6,891,010. Moreover, the use of silicon containing monomers having certain fluorinated side groups, i.e. —(CF₂)—H, have been found to improve compatibility between the hydrophilic and silicon containing monomeric units, as described in U.S. Pat. Nos. 5,387,662 and 5,321,108.

Those skilled in the art have long recognized the need for modifying the surface of such silicon containing contact lenses so that they are compatible with the eye. It is known that increased hydrophilicity of the contact lens surface improves the wettability of the contact lenses. This in turn is associated with improved wear comfort of contact lenses. Additionally, the surface of the lens can affect the lens's susceptibility to deposition, particularly the deposition of proteins and lipids from the tear fluid during lens wear. Accumulated deposition can cause eye discomfort or even inflammation. In the case of extended wear lenses (i.e. lenses used without daily removal of the lens before sleep), the surface is especially important, since extended wear lens must be designed for high standards of comfort and biocompatibility over an extended period of time.

Silicon containing lenses have been subjected to plasma surface treatment to improve their surface properties, e.g., surfaces have been rendered more hydrophilic, deposit resistant, scratch-resistant, or otherwise modified. Examples of previously disclosed plasma surface treatments include subjecting contact lens surfaces to a plasma comprising an inert gas or oxygen (see, for example, U.S. Pat. Nos. 4,055,378; 4,122,942; and 4,214,014); various hydrocarbon monomers (see, for example, U.S. Pat. No.4,143,949); and combinations of oxidizing agents and hydrocarbons such as water and ethanol (see, for example, WO 95/04609 and U.S. Pat. No. 4,632,844). U.S. Pat. No. 4,312,575 to Peyman et al. discloses a process for providing a barrier coating on a silicon containing or polyurethane lens by subjecting the lens to an electrical glow discharge (plasma) process conducted by first subjecting the lens to a hydrocarbon atmosphere followed by subjecting the lens to oxygen during flow discharge, thereby increasing the hydrophilicity of the lens surface.

U.S. Pat. Nos. 4,168,112, 4,321,261 and 4,436,730, all issued to Ellis et al., disclose methods for treating a charged contact lens surface with an oppositely charged ionic polymer to form a polyelectrolyte complex on the lens surface that improves wettability.

U.S. Pat. No. 4,287,175 to Katz discloses a method of wetting a contact lens that comprises inserting a water-soluble solid polymer into the cul-de-sac of the eye. The disclosed polymers include cellulose derivatives, acrylates and natural products such as gelatin, pectins and starch derivatives.

The present invention provides a method of surface modifying contact lenses and like medical devices through the use of copolymerizable functionality between the lens monomer mix and the reactive macromonomer coated on the mold surface. Although only contact lenses will be referred to hereinafter for purposes of simplicity, such reference is not intended to be limiting since the subject method is suitable for surface modification of other medical devices such as phakic and aphakic intraocular lenses and corneal implants as well as contact lenses. Reactive groups of the polymeric materials of the monomer mix which forms the contact lenses and other biomedical devices are used to form covalent chemical linkages with the reactive macromonomer(s) coated on the mold surface. The preferred reactive macromonomer for use in the present invention are selected based on the reactive groups of the lens monomer mix. In accordance with the present invention, the one or more reactive macromonomers selected for coating the mold surface should have complementary polymerizable functionality to that of the reactive groups of the monomer mix. Such complementary polymerizable functionality allows the reactive macromonomer(s) to be polymerized into the lens matrix. The one or more reactive macromonomers are thus chemically bound to the surface of the contact lens or like medical device to achieve surface modification thereof.

The poloxamer and/or poloxamine may be functionalized to provide the desired reactive macromonomer. The functionality can be varied and is determined based upon the intended use of the functionalized PEO- and PPO-containing block copolymers. That is, the PEO- and PPO-containing block copolymers are reacted to provide end-terminal functionality that is complementary with the reactivity of the lens forming monomer mixture. By block copolymer we mean to define the poloxamer and/or poloxamine as having two or more blocks in their polymeric backbone(s). Variation in the number of PEO- and/or PPO - containing blocks in the copolymer will vary the HLB of the copolymer and thus its surface activity.

The foregoing reaction sequences are intended to be illustrative, not limiting. Examples of reaction sequences by which PEO- and PPO-containing block copolymers can be end-functionalized to provide end-terminal reactive functionalized surfactant(s) are provided below:

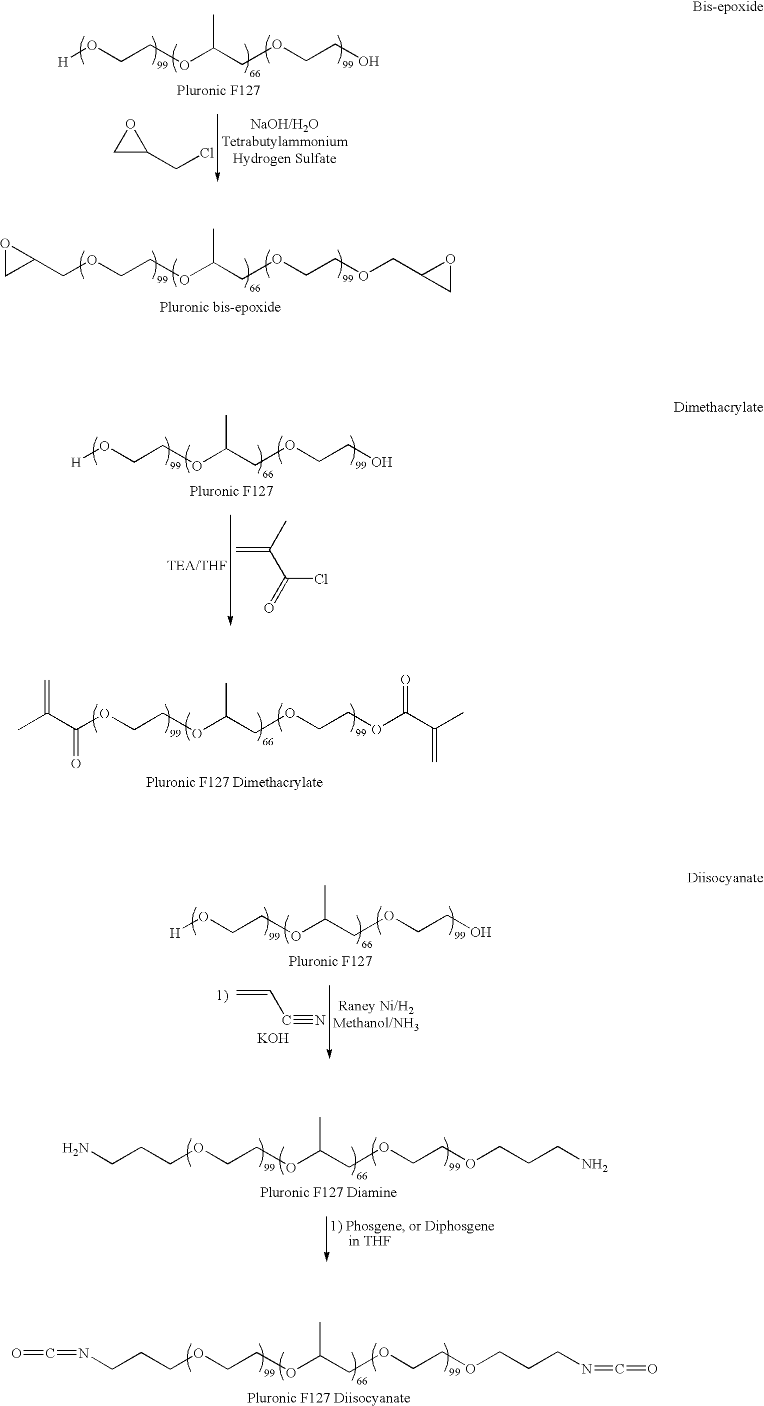

Further provided herein are certain exemplary, but non-limiting, examples of reactions for providing functionalized termini for PEO- and PPO-containing block copolymers. It is to be understood that one of ordinary skill in the art would be able to determine other reaction methods without engaging in an undue amount of experimentation. It should also be understood that any particular block copolymer molecule shown is only one chain length of a polydispersed population of the referenced material. Poloxamer block copolymers are known compounds and are generally available under the trademark PLURONIC. Poloxamers generally have the following structure:
HO(C₂H₄O)ₐ(C₃H₆O)_{b}(C₂ H₄O)ₐH
Reverse poloxamers are also known block copolymers and generally have the following structure:
HO(C₃H₆O)_{b}(C₂H₄O)ₐ(C₃H₆O)_{b}H

PEO- and PPO-containing block copolymers are presently preferred. One such copolymer that can be used with the method of the invention, is Pluronic® F127, a block copolymer having the structure [(polyethylene oxide)₉₉-(polypropylene oxide)₆₆-(polyethylene oxide)₉₉]. The terminal hydroxyl groups of the copolymer are functionalized to allow for copolymerization of the MSMTP (mold surface modification treatment polymer) material with the lens monomer mix.

More specifically, surface modification of contact lenses having reactive copolymers in accordance with the present invention requires one or more MSMTPs. Examples of MSMTPs useful in the practice of the present invention are end terminal functionalized poloxamers and poloxamines.

Polymerizable poloxamers and poloxamines as comonomers in forming polymeric devices have been developed and are disclosed in U.S. patent application Ser. No. 11/020,541, the contents of which are incorporated by reference herein.

Because of the hydrophilic-lipophilic balance (HLB) of these surfactants, the use of these materials as surface coatings for biomedical devices provides desirable results with regard to bacterial attachment and lipid deposition. By the term “modulation” of the solubility of these surfactants in monomer mixtures, we mean to refer to the HLB of the surfactants aiding in their solubility in various lens monomer mixtures.

Surface structure and composition determine many of the physical properties and ultimate uses of solid materials. Characteristics such as wetting, friction, and adhesion or lubricity are largely influenced by surface characteristics. The alteration of surface characteristics is of special significance in biotechnical applications where biocompatibility is of particular concern. Thus, it is desired to provide a silicon containing hydrogel contact lens with an optically clear, hydrophilic surface film that will not only exhibit improved wettability, but which will generally allow the use of a silicon containing hydrogel contact lens in the human eye for an extended period of time. In the case of a silicon containing hydrogel lens for extended wear, it would be further desirable to provide an improved silicon-containing hydrogel contact lens with an optically clear surface film that will not only exhibit improved lipid and microbial behavior, but which will generally allow the use of a silicon-containing hydrogel contact lens in the human eye for an extended period of time. Such a surface treated lens would be comfortable to wear in actual use and would allow for the extended wear of the lens without irritation or other adverse effects to the cornea.

It would also be desirable to apply these surface enhancing coatings to implantable medical devices such as intraocular lens materials to reduce the attachment of lens epithelial cells to the implanted device and to reduce friction as the intraocular lens passes through an inserter into the eye.

Although the teachings of the present invention are preferably applied to soft or foldable contact lenses or like medical devices formed of a foldable or compressible material, the same may also be applied to harder, less flexible, lenses formed of a relatively rigid material such as poly(methyl methacrylate) (PMMA).

The present invention is also directed toward surface treatment of a polymeric device. The surface treatment comprises the covalent bonding of an end-terminal reactive functionalized surfactant(s) that is copolymerized with the monomeric units comprising the monomer mixture.

The reactive macromonomer(s) useful in certain embodiments of the present invention may be prepared according to syntheses well known in the art and according to the methods disclosed in the following examples. Surface modification of contact lenses using one or more MSMTPs in accordance with the present invention is described in still greater detail in the examples that follow.

### EXAMPLES

### Example 1

### Synthesis of End-terminal Functionalized Copolymers

6.00 g of PLURONIC F127 was placed in a round bottom flask and dried thoroughly via azeotropic distillation of toluene (100 ml). The round bottom flask was then fitted with a reflux condenser and the reaction was blanketed with nitrogen gas. Anhydrous tetrahydrofuran (THF) (60 ml) was added to the flask and the reaction was chilled to 5° C. with 15 equivalents (based upon the hydroxyl endgroups) of triethylamine (TEA) was added (2.0 ml). 1.4 ml of methacryoyl chloride (15 equivalents) was dropped into the reaction mixture through an addition funnel and the reaction mixture was allowed to warm to room temperature and then stirred overnight. The reaction mixture was then heated to 65° C. for 3 hours. Precipitated salt (TEA-HCl)was filtered from the reaction mixture and the filtrate was concentrated to a volume of around 355 mL and precipitated into cold heptane. Two further reprecipitations were performed to reduce the amount of TEA-HCl salt to less than 0.2% by weight. NMR analysis of the final polymer showed greater than 90% conversion of the hydroxyl endgroups to the methacrylated endgroups.

### Example 2

### Synthesis of Surfactant Epoxides

10.00 gms of PLURONIC F38 (2.13E-03 mol) are placed in a round bottom flask and dried thoroughly via azeotropic distillation of toluene and then dissolved in 100 mL of THF. 10 equivalents of solid NaH were added into the flask (0.51 gm; 2.13E-02 mol). Next, 1.67 mL of epichlorohydrin (2.1 3E-03 mol) was added to the reaction mixture and mixed well and the reaction mixture was heated to reflux for 24 hours. The reaction mixture was cooled and a scoop of magnesium sulfate and silica gel was added to remove any water. This was mixed well for 5 minutes and then filtered off the insolubles. The filtrate was concentrated to around 30 mL final volume and the product was precipitated into heptane and isolated by filtration. NMR confirmed the presence of epoxide groups on the termini of the polymer.

### Example 3

### Purification of End-terminal Functionalized Copolymers

Different dimethacrylated PLURONICS and TETRONICS had to be purified by different techniques depending upon their ability to precipitate and their solubility in water. The purification technique used for each example is listed in Table 2 below:

TABLE 2

| # | | Mol. Wt. | % EO/HLB | Form | Method | Water Soluble |
|---|---|---|---|---|---|---|
| | Pluronics | | | | | |
| 1 | Pluronic F127 | 12,600 | 70/22 | solid | Prec/Dialysis | + |
| 2 | Pluronic P105 | 6,500 | 50/15 | paste | Dialysis | + |
| 3 | Pluronic P123 | 5,750 | 30/8 | paste | Dialysis | + |
| 4 | Pluronic F38 | 4,700 | 80/31 | solid | Prec/Dialysis | + |
| 5 | Pluronic L101 | 3,800 | 10/1 | liquid | Water/Centrifuge | − |
| 6 | Pluronic L121 | 4,400 | 10/1 | liquid | Water/Centrifuge | − |
| | Reverse Pluronics | | | | | |
| 7 | Pluronic 10R5 | 1,950 | 50/15 | liquid | Dialysis | + |
| 8 | Pluronic 31R1 | 3,250 | 10/1 | liquid | Water/Centrifuge | − |
| 9 | Pluronic 25R4 | 3,600 | 40/8 | paste | Dialysis | + |
| | Tetronics | | | | | |
| 10 | Tetronic 1107 | 15,000 | 70/24 | solid | Prec/Dialysis | + |
| 11 | Tetronic 904 | 6,700 | 40/15 | paste | Dialysis | + |
| 12 | Tetronic 908 | 25,000 | 80/31 | solid | Prec/Dialysis | + |
| 13 | Tetronic 1301 | 6,800 | 10/2 | liquid | Water/Centrifuge | − |
| | Reverse Tetronics | | | | | |
| 14 | Tetronic 150R1 | 8,000 | 10/1 | liquid | Water/Centrifuge | − |
| 15 | Tetronic 90R4 | 7,240 | 40/7 | liquid | Dialysis | + |
| | Other | | | | | |
| 16 | PEO | 10,000 | 100/>31 | solid | Prec/Dialysis | + |
| 17 | PPO | 3,500 | 0/<1 | liquid | Water/Centrifuge | − |

method column refers to the method that can be used for purification of the resulting functionalized surfactant. Prec means that the polymer can be dissolved into tetrahydrofuran (THF) and precipitated in hexane, with several reprecipitations leading to pure product (3×). Dialysis of the water soluble functionalized surfactant in 500-1000 molecular weight cut off dialysis tubing followed by freeze drying is a viable technique for purification of all water soluble PLURONICS and TETRONICS. Centrifuge means that functionalized surfactant is stirred in water and the water insoluble functionalized surfactant is then isolated by centrifugation and decanting off the top water layer. In the Water Soluble column, + means the functionalized surfactant is water-soluble and − means it is insoluble in water.

### Example 4

### Coating of Substrate by Mold Coating

Four coating solutions were prepared to coat the anterior molds with either Pluronic F127-DM or F127-VC (structures provided below).

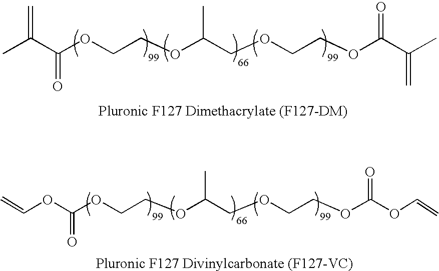

These solutions were as follows:

1% by weight of F127-DM in dichloromethane

2) 10% by weight of F127-DM in dichloromethane

3) 1% by weight of F127-VC in dichloromethane

4) 10% by weight of F127-VC in dichloromethane

The above 4 solutions were used to coat anterior molds made of Exxon Achieve resin (polypropylene) in one of two ways: 1) 50 μL of the solution was dropped onto the mold and then the mold was spun to get rid of excess solvent and polymer. This process will be referred to as spin coating. 2) Anterior mold was spray coated using an airbrush and the above solutions (referred to as spray coating). These treated molds were then used to make a lens with RD1661 formulation (fluorovynagel). Note: The residence time of the monomer in the mold before the start of polymerization was less than 5 minutes. The set of lenses made are summarized in Table 4. (A-H)

TABLE 4

| | 1% | 10% | 1% | 10% |
|---|---|---|---|---|
| | F127-DM | F127-DM | F127-VC | F127-VC |
| spin coat | A | B | D | D |
| spray coat | E | F | G | H |

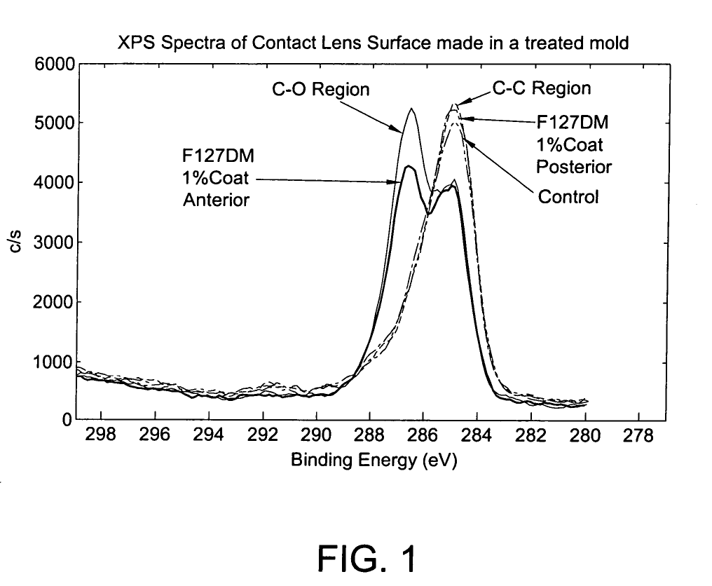

After polymerization, lenses were removed from molds, extracted in IPA, transferred to deionized water, and finally placed in PBS buffer before being autoclave sterilized. After sterilization of lenses, surfaces were examined by XPS analysis and it was conclusively demonstrated that the reactive polymer (F127-DM) was transferred to the surface of the lens material. FIG. 1 shows the carbon region of the XPS spectra and it can be seen that there is an increased contribution to the C—O region (shoulder near 287 eV) due to the presence of Pluronic F127 on the surface of the lens. FIG. 1 also shows the XPS spectra of control lens, the posterior surface of two lenses and the anterior surface of two lenses. The anterior mold for the lenses used in this study had 1% of F127-DM in dichloromethane spun coat on the surface. As you can clearly see in the spectra, the anterior surface of the lens has a distinctive trace from the posterior surface (which corresponds to the control trace) in which there is an enhanced C—O contribution from the presence of poloxamer on this lens surface.

One method of coating a medical device is to dissolve the SMTP in an organic solvent. For example, when making a contact lens, when the lens monomer formulation is placed in the mold and polymerized, the coating material is copolymerized into the lens matrix and is present at the surface of the lens. The solubility of the coating material in the lens formulation is modulated as to now allow the complete dissolution of the SMTP (surface modification treatment polymer) into the formulation. Coating of the molds can be optimized by coating solvent, concentration of reactive monomer in the solvent, spin speed (in the case of spin coating), and spraying conditions.

### Example 5

XPS Spectra of Contact Lens Surfaces Made in a Treated Mold

In FIG. 1 is showed the XPS spectra of control lens (green), the posterior surface of two lenses (black) and the anterior surface of two lenses (red). The anterior mold for the lenses used in this study had 1% of F127-DM in chloroform spun coat on the surface. As you can clearly see in the spectra, the anterior surface of the lens has a distinctive trace from the posterior surface (which corresponds to the control trace) in which there is an enhanced C—O contribution from the presence of Pluronic on this lens surface.

Contact lenses manufactured using the unique materials of the present invention are used as customary in the field of ophthalmology. While there is shown and described herein certain specific structures and compositions of the present invention, it will be manifest to those skilled in the art that various modifications may be made without departing from the spirit and scope of the underlying inventive concept and that the same is not limited to particular structures herein shown and described except insofar as indicated by the scope of the appended claims.

What is claimed is:

1. A method for forming a device having a covalently bound surface coating, the method comprising:
providing a reactive monomer comprising a functionalized surfactant dissolved in a solvent;
providing a mold;
coating at least one surface of the mold with the reactive monomer dissolved in the solvent;
providing a device forming monomer mixture to the mold; and
subjecting the monomer mixture and reactive monomer to conditions sufficient to provide a copolymerized device having a covalently bound surface coating.

2. The method of claim 1 wherein the reactive monomer dissolved in an organic solvent is applied to the mold by a method selected from the group consisting of spin coating, dipcoating and spray coating.

3. The method of claim 1 wherein the solubility of the coating material in the lens formulation is modulated to allow from partial to complete dissolution of the reactive monomer into the device forming monomer mix.

4. The method of claim 1 wherein the coating of the molds is optimized by varying at least on of the following conditions selected from the group consisting of coating solvent, concentration of reactive monomer in the solvent, spin speed and spraying conditions.

5. A method of surface modifying a medical device through the use of complementary reactive copolymerizable functionality between the device forming monomer mix and the reactive macromonomer coated on the mold surface, the method comprising:
providing a reactive monomer comprising a functionalized surfactant having an HLB value of at least about 8 dissolved in a solvent;
providing a mold;
coating at least a surface of the mold with the reactive monomer;
providing a device forming monomer mixture to the mold; and
subjecting the monomer mixture and reactive monomer to conditions sufficient to provide a copolymerized device having at least one surface modified through the use of complementary reactive copolymerizable functionality between the device forming monomer mix and the reactive macromonomer coated on the mold surface.

6. The method of claim 5 wherein the device formed is selected from the group consisting of contact lenses, phakic intraocular lenses, aphakic intraocular lenses and corneal implants.

7. The method of claim 5 wherein the reactive macromonomer is selected based on the reactive groups of the device forming monomer mix.

8. The method of claim 5 wherein the functionalized surfactant has an HLB value of at least about 22.

9. The method of claim 5 wherein the functionalized surfactant is a functionalized block copolymer of PEO and PPO.

10. The method of claim 5 wherein the functionalized surfactant is selected from the group consisting of functionalized poloxamers and poloxamines.

11. A method of surface modifying a medical device, the method comprising:
providing a reactive monomer comprising a dimethacrylated poloxamer having a molecular weight (number average) of at least 4,500 in a solvent;
providing a mold;
spin coating at least a surface of the mold with the reactive monomer;
providing a device forming monomer mixture comprising silicon containing monomers to the mold; and
subjecting the monomer mixture and reactive monomer to conditions sufficient to provide a copolymerized device having at least one modified surface.

12. A method of surface modifying a medical device, the method comprising:
providing a reactive monomer comprising a vinyloxy terminated poloxamer having a molecular weight (number average) of at least 4,500 in a solvent;
providing a mold;
spin coating at least a surface of the mold with the reactive monomer;
providing a device forming monomer mixture comprising silicon containing monomers to the mold; and
subjecting the monomer mixture and reactive monomer to conditions sufficient to provide a copolymerized device having at least one surface modified through the use of complementary reactive copolymerizable functionality between the device forming monomer mix and the reactive macromonomer coated on the mold surface.
